(19) United States
(12) Patent Application Publication
(10) Pub. No.: US 2022/0381886 A1
(43) Pub. Date: Dec. 1, 2022

(54) DETECTION SYSTEM AND METHOD USING A LINE DETECTOR

(71) Applicant: Veoneer US, LLC, Wilmington, DE (US)

(72) Inventors: Bernard de Mersseman, Andover, MA (US); Olov von Hofsten, Stockholm (SE)

(73) Assignee: Veoneer US, LLC, Wilmington, DE (US)

(21) Appl. No.: 17/329,691

(22) Filed: May 25, 2021

(51) Int. Cl. G01S 7/481; G01S 17/894; G01S 17/42; H04N 5/225; H04N 5/232; G02B 26/12

(52) U.S. Cl. CPC G01S 7/4817; G01S 7/4816; G01S 17/894; G01S 17/42; H04N 5/2259; H04N 5/23238; G02B 26/12

(57) ABSTRACT

A detection system, and method of using the same, for a vehicle in an environment. The system includes a line detector with a plurality of optical receiver elements arranged in a line. The optical receiver elements receive light from the environment and the line detector captures an image of the environment in a series of line scans. An optical scanning element rotates around an axis to change a field of view of the line detector with respect to the environment. The optical scanning element has a glass body defined by four glass sides and a reflective member within the glass body.

### FIELD OF THE TECHNOLOGY

The subject disclosure relates to object detection and more particularly to detection systems for vehicles.

### BACKGROUND OF THE TECHNOLOGY

Vehicles benefit from having detection systems which seek information on a wide variety of information about the vehicle surroundings. Detection systems can be used for collision avoidance, self-driving, cruise control, and the like. In some cases, cameras can be implemented as part of a detection system to obtain image data related to the surrounding environment. However, it can be a challenge to scan the environment to obtain a very large field of view for the camera. Further, the image data collected may be inaccurate as the camera attempts to scan the environment while the vehicle is also moving and the respective position of objects around the vehicle is changing.

### SUMMARY OF THE TECHNOLOGY

In light of the needs described above, in at least one aspect, the subject technology relates to a vehicle detection system which effectively uses a line camera in conjunction with an optical scanning element to image a large field of view.

In at least one aspect, the subject technology relates to a detection system for a vehicle in an environment. The detection system includes a line detector including a plurality of optical receiver elements arranged in a line, the optical receiver elements each configured to receive light from the environment, the line detector configured to capture an image of the environment in a series of line scans. The detection system also includes an optical scanning element, the optical scanning element having a glass body defined by four glass sides and a reflective member within the glass body. The optical scanning element is configured to rotate around an axis to change a field of view of the line detector with respect to the environment.

In some embodiments, the exterior of the glass body is formed by four transmissive faces. The transmissive faces include a first pair of two transmissive faces on a first side of the reflective member and forming a first isosceles right triangular prism with the reflective member such that the reflective member is the hypotenuse. The transmissive faces also include a second pair of two transmissive faces on a second side of the reflective member and forming a second isosceles right triangular prism with the reflective member such that the reflective member is the hypotenuse.

In some embodiments, the detection system includes a light transmitter configured to transmit a light beam into the environment. The line detector can be configured to receive said light beam after the light beam returns from the environment. In some cases, the light transmitter is positioned to face orthogonal to the optical receiver elements of the line detector. In some embodiments, the detection system includes a 90 degree reflector. The 90 degree reflector is positioned such that the light transmitter and the line detector are coaxial the 90 degree reflector. The 90 degree reflector is configured to redirect the light beam from the light transmitter towards the optical scanning element. In some cases, the 90 degree reflector is one or more of the following: a reflective mirror; a reflective prism; or a polarized beam splitter. In some cases, the system includes a Powell lens positioned between the 90 degree reflector and the optical scanning element. The Powell lens is configured to expand light from the 90 degree reflector from a pencil beam into a fan beam, directing the fan beam towards the optical scanning element co-axial to the line detector. In some cases, the light transmitter is a near-infrared laser transmitter and the light beam is near-infrared light. The detection system can then include a near-infrared filter positioned between the optical scanning element and the line detector such that unwanted background light from the environment is filtered through the near-infrared filter before receipt by the optical receiver elements.

In some embodiments, the line detector is a time delay integrating line camera. In some cases, the optical receiver elements of the line detector are one of the following: a linear array of avalanche photodiodes; or a linear array of single photon avalanche photodiodes.

In at least one aspect, the subject technology relates to a method for capturing image data of an environment. The method includes providing a detection system on a vehicle. The detection system includes a line detector with a plurality of optical receiver elements arranged in a line. The detection system also includes an optical scanning element, the optical scanning element having a glass body defined by four glass sides and a reflective member within the glass body. The optical scanning element is rotated around an axis to change a field of view of the line detector with respect to the environment. As the optical scanning element rotates light is received from the environment, by the optical receiver elements, such that the line detector captures an image of the environment in a series of line scans.

In some embodiments, the exterior of the glass body is formed by four transmissive faces. The transmissive faces include a first pair of two transmissive faces on a first side of the reflective member and forming a first isosceles right triangular prism with the reflective member such that the reflective member is the hypotenuse. The transmissive faces also include a second pair of two transmissive faces on a second side of the reflective member and forming a second isosceles right triangular prism with the reflective member such that the reflective member is the hypotenuse.

In some embodiments, the detection system further includes a light transmitter. The method then includes transmitting, with the light transmitter, a light beam into the environment. The line detector then receives the light beam after the light beam returns from the environment. In some cases, the method further includes positioning the light transmitter to face orthogonal to the optical receiver elements of the line detector. In some cases, the detection system includes a 90 degree reflector. The method then includes arranging the 90 degree reflector such that the light transmitter and the line detector are co-axial. The light beam from the light transmitter is then redirected, with the 90 degree reflector, towards the optical scanning element. In some cases, the 90 degree reflector is one or more of the following: a reflective mirror; a reflective prism; or a polarized beam splitter. In some embodiments, the detection system can include a Powell lens. The method can then include positioning the Powell lens between the 90 degree reflector and the optical scanning element. The Powell lens can then to expand light from the 90 degree reflector from a pencil beam into a fan beam, directing the fan beam towards the optical scanning element co-axial to the line detector. In some embodiments, the light transmitter is a near-infrared laser transmitter and the light beam is near-infrared light. The detection system can then further include a near-infrared filter. Further, the method can then include positioning the near-infrared filter between the optical scanning element and the line detector such that light from environment passes through the near-infrared filter before receipt by the optical receiver elements.

The light transmitter can emit continuously or modulate the transmitted light. Synchronizing and gating the receiver can mitigate the far range clutter or provide a direct estimation of the depth in the image based on time of flight.

In some embodiments, the line detector is a time delay integrating line camera. In some cases, the optical receiver elements of the line detector are one of the following: a linear array of avalanche photodiodes; or a linear array of single photon avalanche photodiodes.

### BRIEF DESCRIPTION OF THE DRAWINGS

So that those having ordinary skill in the art to which the disclosed system pertains will more readily understand how to make and use the same, reference may be had to the following drawings.

FIG. 1 is an overhead schematic diagram of a detection system for a vehicle in accordance with the subject technology.

FIG. 2A is a perspective view of the detection system of FIG. 1.

FIG. 2B is a side view of the detection system of FIG. 1.

FIG. 2C is an overhead view of the detection system of FIG. 1.

FIG. 3A is a front perspective view of an optical scanning element for a detection system in accordance with the subject technology.

FIG. 3B is a bottom perspective view of the optical scanning element of FIG. 3A.

FIG. 4 is a side schematic diagram of components of a detection system in accordance with the subject technology.

FIGS. 5A-5B are overhead schematic diagrams of exemplary scan angles of a detection system in accordance with the subject technology.

### DETAILED DESCRIPTION

The subject technology overcomes prior art problems associated with vehicle detection systems. In brief summary, the subject technology provides a detection system utilizing an optical scanning element allowing a line detector to scan a surrounding environment. The advantages, and other features of the systems and methods disclosed herein, will become more readily apparent to those having ordinary skill in the art from the following detailed description of certain preferred embodiments taken in conjunction with the drawings which set forth representative embodiments of the subject technology. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be at a higher elevation).

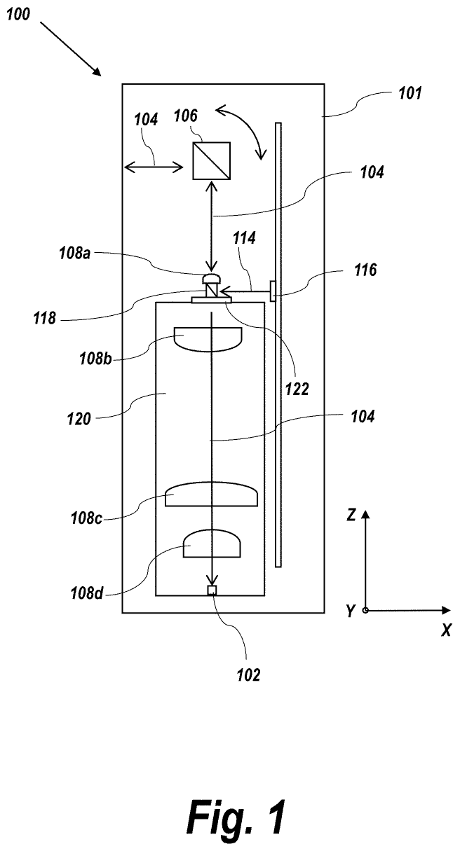

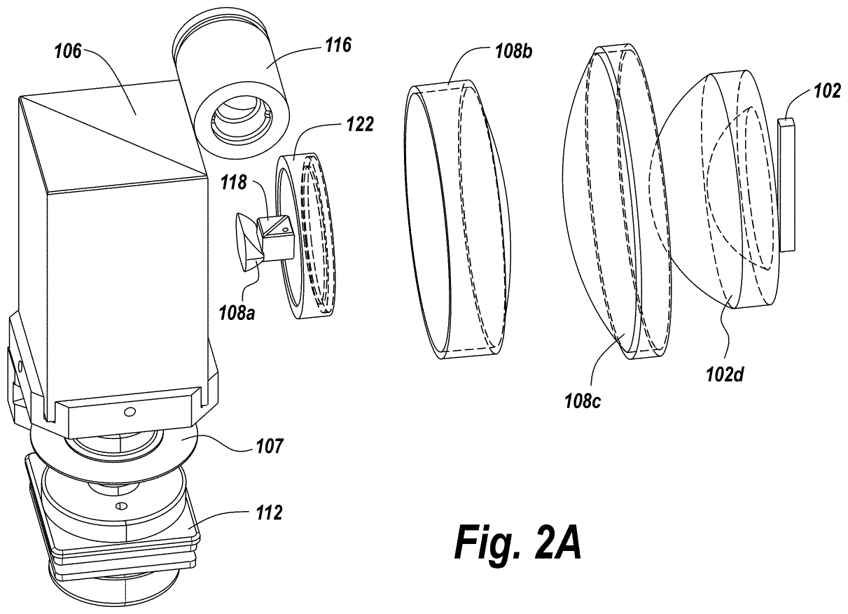

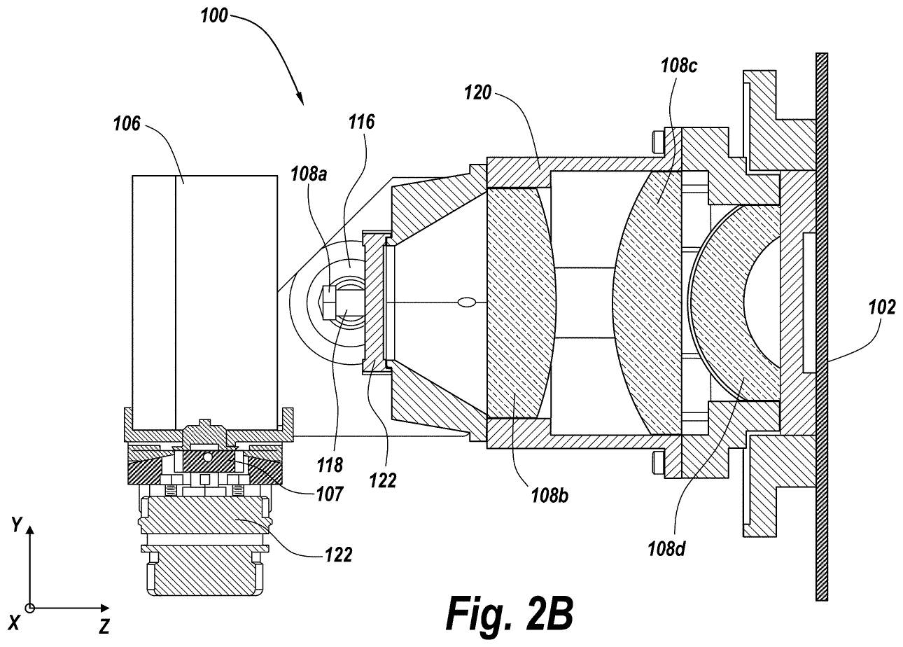

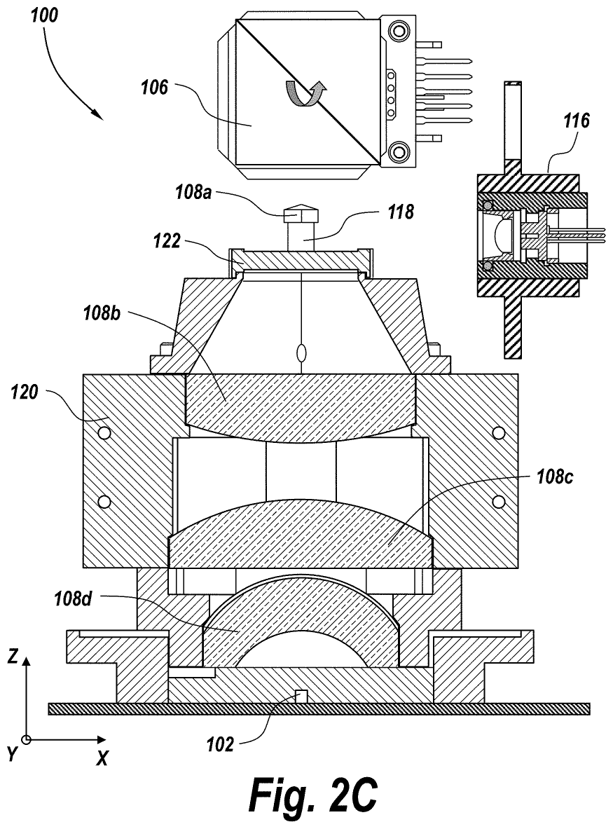

Referring now to FIGS. 1-2C, a detection system 100 for a vehicle in accordance with the subject technology is shown. The detection system 100 can be mounted on or within a vehicle (not distinctly shown) and can be used generally to gather information and generate data on the surrounding environment. The detection system 100 can include a protective outer housing 101, storing the other components discussed herein and allowing the detection system 100 to be attached to the vehicle as desired. It should be understood that the housing 101 will include apertures to allow light to pass therethrough as needed.

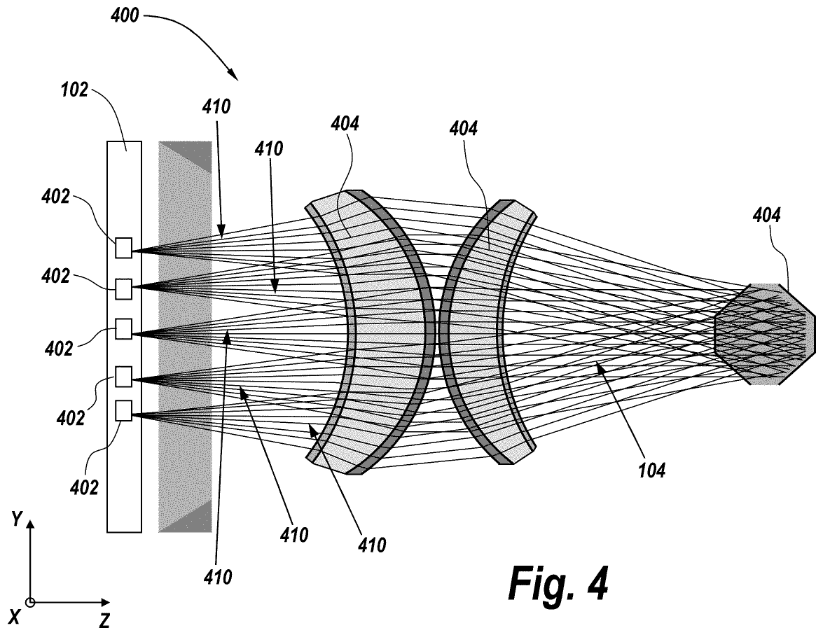

The detection system 100 utilizes a line detector 102 which employs a plurality of optical receiver elements arranged in a line (see optical receiver elements 402 of in FIG. 4). The optical receiver elements collect light 104 returning from the environment. In particular, the nature of a line detector 102 is such that the optical receiver elements receive the returning light 104 across the line of receiver elements, creating a an image of the environment in a series of line scans, as opposed to grabbing an entire frame at once like a traditional camera. Images are built by continuously grabbing lines at a given rate and using that data to fill a matrix. Lines are accrued into a frame one at a time with the newest line first, and the position of every other line being shifted from there. In general, the line detector 102 discussed herein has been found to be particularly advantageous for use within the detection system 100. This is due to the fact that line scans are able to take images of various shaped objects (e.g. cylindrical) in the environment with zero distortion.

The line detector 102 can be one of various types of line detectors, as are known in used in various imaging systems. In particular, it has been found advantageous in some cases, for the line detector 102 to be a time delay integrating (TDI) line camera. A TDI line camera is capable of greatly reducing, or removing, blur caused by the scanning being imaged as they move relative to the line detector 102, and as the environment is scanned. This is done by the line detector 102, or a related processor, shifting measurements taken by the optical receivers to account for scan speed. Alternatively, the line detector 102 can include a linear array of avalanche photodiodes, or a linear array of single photon avalanche photodiodes.

The detection system 100 includes an optical scanning element 106 which rotates around the y-axis (i.e. the vertical axis) to redirect the field of view of the line detector 102, allowing the system 100 to scan the environment in the azimuth direction. An encoder 107 positioned underneath the optical scanning element 104 measures and controls movement of a rotary actuator 112, such as a brushless motor or voice coil, which drives the rotation of the optical scanning element 106. As will be discussed in more detail below, the optical scanning element 106 can be a generally glass prism with a reflective member running through a cross section of the prism.

The system 100 includes a series of lenses 108a-108d (generally 108) between the optical scanning element 106 and line detector 102 for redirecting light. Lens 108a, which can be a Powell lens, causes outgoing light from a light transmitter 116 to expand, or fan out, while passing the fanned beam to the optical scanning element 106. Powell lens 108a also ensures that the transmitted light and is co-axial to the line detector 102. The transmitted light is scanned (i.e. redirected) by the scanning element 106 across the environment, and upon return, passes into a housing 120 containing the remaining lenses 108b-108d. The returning light 104 then passes through the remaining lenses 108b-108d where the light 104 is focused and passed for receipt by the line detector 102.

While the system 100 can sometimes function on passive illumination of the surrounding environment, the detection system 100 can also include the light transmitter 116 for active illumination. The light transmitter 116 faces generally orthogonal to the optical axis of the line detector 102 along the azimuth plane (i.e. the x-z plane). The light transmitter 116 directs a light beam 114 at the 90 degree reflector, which redirects the light beam 114 through the lens 108a and to the optical scanning element 106 along the same optical path as the returning light 104. As such, rotation of the optical scanning element 106 redirects the transmitted light beam 114 to scan the environment in accordance with the field of view of the line detector 102. The 90 degree reflector 118 shown herein is a simple reflective mirror, with a reflective surface positioned at a 45 degree angle to the light transmitter 116 with respect to the x-z plane and centrally aligned between the optical scanning element 106 and the line detector 102. This results in a small portion of the return light 104 being blocked by the 90 degree reflector 118. In various implementations, the 90 degree reflector 118 could alternatively be a reflective prism, or a polarized beam splitter which reflects a portion of light and allows a portion of light to pass therethrough.

It can be advantageous to modulate the transmitted light beam 114 in order to mitigate background clutter or provide an estimation of the range by time of flight measurement technique.

In some cases the system 100 can be configured to utilize near-infrared (NIR) light. In a vehicle setting, this can be advantageous as it allows the system 100 to operate without risking potentially impairing the vision of other drivers on the road. As such, the light transmitter 116 can be a collimated NIR laser transmitter and the transmitted light 114 can be within the NIR spectrum. Similarly, the line detector can be configured to detect near-infrared light received from the environment. The housing 120 containing the line detector 102 can also include an NIR filter 122 which filters all incoming light 104, blocking light that is not within the NIR spectrum from being received by the line detector 102 and improving accuracy of the line detector 102.

Although not shown distinctly, it should be understood that the detection system 100 also utilizes all necessary components to store and process data, carry out instructions, and communicate with other components of the vehicle. For example, the detection system 100 can include a processing module with a processor configured to execute programmed instructions based on the data generated about the environment as well as input data. The detection system 100 can also include components necessary for wireless communication capabilities, such as a wireless transmitter/receiver to transmit and receive information and commands. It should be understood that the particular components of the detection system 100 shown herein are exemplary only, and presented to explain the functions of the detection system 100 disclosed herein. The system 100 may include other standard components which are part of typical vehicle detection systems, as would be understood by one of ordinary skill in the art. The exemplary components shown herein are not absolutely necessary to implement the subject technology in all cases.

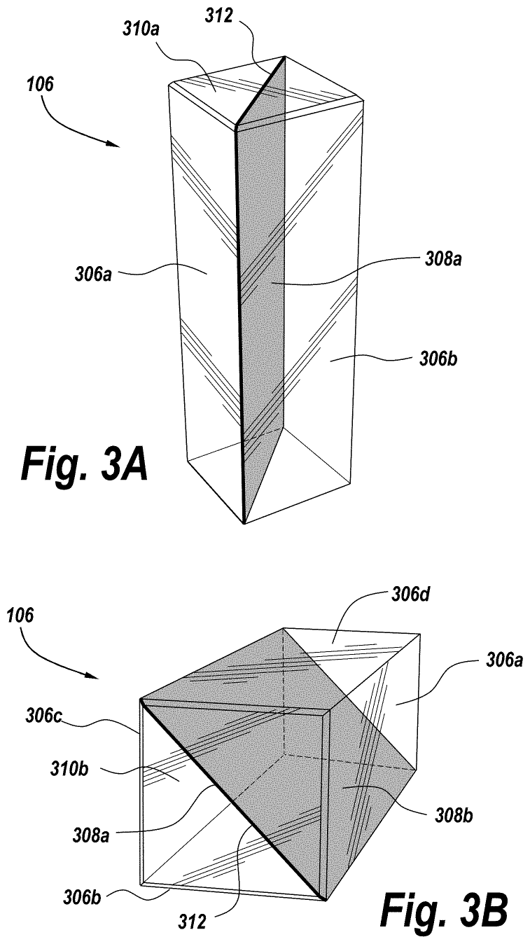

Referring now to FIGS. 3A-3B, the optical scanning element 106 is shown and described in further detail. The optical scanning element 106 has a glass body in the shape of a rectangular prism with an exterior defined by four outer glass faces 306a, 306b, 306c, 306d (generally 306) forming the prism sides. The sides 306 extend between ends 310a, 310b (generally 310) which are similarly formed by glass faces. In general, the sides 306 sit at right angles to one another. The sides 306 are generally transmissive, allowing light to pass therethrough, and allowing light to pass through the glass body of the optical scanning element 106, while redirecting the light as discussed in more detail below. A flat rectangular reflective member 312 with opposing reflective surfaces 308a, 308b forms a diagonal cross section of the optical scanning element 106. The reflective member 312 extends the length of the optical scanning element 106 between the ends 310, running parallel to the outer sides 306. In particular, two of the sides 306b, 306c are on a first side 308a of the reflective member 312, light passing through those sides 306b, 306c interacting with the first side 308a of the reflective member 312. In effect, the sides 306b, 306c form an isosceles right triangular prism with the first side 308a of the reflective member 312 with the reflective member 312 being the hypotenuse. Similarly other two sides 306a, 306d are on a second side 308b of the reflective member 312, allowing light passing through to interact with the second side 308b of the reflective member 312. The sides 306a, 306d likewise form an isosceles right triangular prism with the second side 308b of the reflective member 312 and with the reflective member 312 being the hypotenuse.

Referring now to FIGS. 1-3B, as the actuator 112 rotates the optical scanning element 106 around the vertical axis (i.e. y-axis), the angle of each side 306 and reflective surface 308 interfacing with light changes. Similarly, rotation of the optical scanning element 106 changes which sides 306 and reflective surface 308 of the optical scanning element 106 interfaces with the light. As light passes through the moving optical scanning element 106, the glass body (and transmissive faces formed by sides 306) of the optical scanning element 106 redirects light and the reflective member 312 completely reflects light which contacts its surface (i.e. sides 308). Rotating the optical scanning element 106 therefore redirects the returning light 104 to change the field of view of the line detector 102 in the azimuth direction. In the case of an actively illuminated detection system 100, rotation of the optical scanning element 106 also changes the direction transmitted light 114 from the light transmitter 116 is directed into the surrounding environment.

Referring now to FIG. 4, an exemplary arrangement of components for use within the detection system 100 is shown generally at 400. The line detector 102 includes a number of separate optical receivers 402, which can be photodiodes or the like, arranged in a vertical line to carry out a line scan. Returning light 104 from the environment is passed through a series of lenses 404, allowing the light 104 to be collimated before the light 104 returns to the line detector 102. Separate light beams 410 are received by each optical receiver 402, the separate beams 410 representing separate areas of the surrounding environment which are imaged. Notably, the lenses 404 shown are exemplary only, and it should be understood that other numbers or arrangements of lenses may be utilized in the detection system 100 described herein. Further, the exemplary arrangement of FIG. 4, a protective glass 408 is included which can be positioned around the line detector 102 and sealed to a surrounding housing to protect the optical receivers 402.

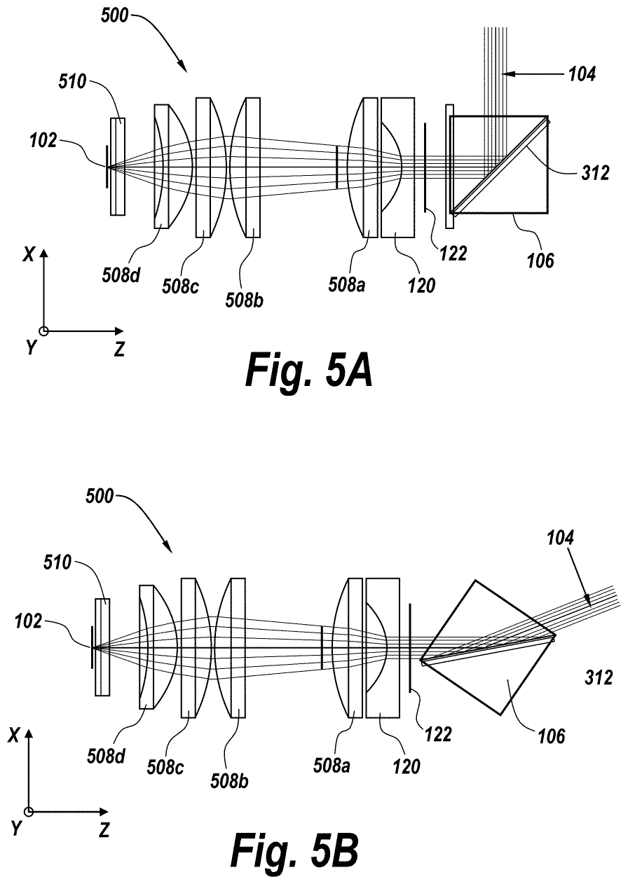

Referring now to FIGS. 5A-5B, overhead schematic diagrams of an exemplary detection system 500 in accordance with the subject technology are shown. The system 500 is similar to the system 100, except as otherwise shown and described herein. In particular, the system 500 does not include active illumination components, and includes a slightly different lens arrangement, including lenses 508a-508d (generally 508). The detection system 500 also shows a protective covering 510, which can be similar to the protective glass 408 of FIG. 4, for protecting the line detector 102. In general, FIGS. 5A-5B show an exemplary rotation of the optical scanning element 106, showing the change in trajectory of the returning light 104 corresponding to the change in field of view of the line detector 102.

In FIG. 5A, the optical scanning element 106 is positioned such that the reflective member 312 is at a 45 degree angle to the line detector 102, providing a field of view of the environment that is substantially 90 degrees to one side of the detection system 500. As the optical scanning element 106 rotates, the angle of the light 104 reflecting off the reflective member 312 changes. Similarly, the changing orientation of the glass body of the optical scanning element 106 redirects light differently depending on the angle of the light 104 entering the optical scanning element 106. FIG. 5B shows the optical scanning element just before the reflective member has been rotated 45 degrees from the position shown in FIG. 5A, causing the field of view to sweep to substantially directly in front of the detection system 500. It should be understood that continued rotation of the optical scanning element 106 will continue to cause a sweep of the field of view in the azimuth direction. For example, the system 500 can complete a 180 degree scan by reaching the mirror of the position shown in FIG. 5A, with the light 104 reflecting off the optical scanning element 106 at a 90 degree angle from the opposite side. In some cases, the detection system 500 can scan even beyond the 90 degree side scan shown in FIG. 5A, and can provide up to 270 degrees of scan range in the azimuth direction. Providing a full 360 degree scan range is also possible, but requires additional components not specifically shown and described herein to redirect the light 104 and ensure that a rear scan is possible without interference from the line detector 102 (or other components of the detection system 500). The line detector 102 will also obtain some breadth in the elevation direction, given the arrangement of the optical elements of the line detector 102 in a vertical line.

Overall, the detection systems shown and described herein are able to image, without distortion, a very wide field of view in the azimuth direction by using a combination of the line detector and the optical scanning element shown herein. Further, the use of the line detector is particularly advantageous for providing an accurate image of the surrounding environment of a vehicle. The solution described herein is advantageous in that it utilizes a relatively inexpensive system with a single optical scanning element, avoiding the pitfalls of complicated and potentially error prone systems utilizing numerous moving parts. As such, the detection systems of the subject technology can provide a high level of detail about the surrounding environment to a vehicle operator, or to automated driving functions within the vehicle or the like, while keeping costs down.

It will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A detection system for a vehicle in an environment, comprising:
a line detector including a plurality of optical receiver elements arranged in a line, the optical receiver elements each configured to receive light from the environment, the line detector configured to capture an image of the environment in a series of line scans; and
an optical scanning element, the optical scanning element having a glass body defined by four glass sides and a reflective member within the glass body, the optical scanning element configured to rotate around an axis to change a field of view of the line detector with respect to the environment.

2. The detection system of claim 1, wherein an exterior of the glass body is formed by four transmissive faces, the four transmissive faces including:
a first pair of two transmissive faces on a first side of the reflective member and forming a first isosceles right triangular prism with the reflective member such that the reflective member is the hypotenuse; and
a second pair of two transmissive faces on a second side of the reflective member and forming a second isosceles right triangular prism with the reflective member such that the reflective member is the hypotenuse.

3. The detection system of claim 1, further comprising a light transmitter configured to transmit a light beam into the environment, wherein the line detector is configured to receive said light beam after the light beam returns from the environment.

4. The detection system of claim 3, wherein the light transmitter is positioned to face orthogonal to the optical receiver elements of the line detector.

5. The detection system of claim 4, further comprising a 90 degree reflector, the 90 degree reflector positioned such that the light transmitter and the line detector are co-axial, wherein the 90 degree reflector is configured to redirect the light beam from the light transmitter towards the optical scanning element.

6. The detection system of claim 5, wherein the 90 degree reflector is one or more of the following: a reflective mirror; a reflective prism; or a polarized beam splitter.

7. The detection system of claim 5, further comprising:
a Powell lens positioned between the 90 degree reflector and the optical scanning element, the Powell lens configured to expand light from the 90 degree reflector from a pencil beam into a fan beam, directing the fan beam towards the optical scanning element co-axial to the line detector.

8. The detection system of claim 3, wherein:
the light transmitter is a near-infrared laser transmitter and the light beam is near-infrared light; and
the detection system further comprises a near-infrared filter positioned between the optical scanning element and the line detector such that unwanted background light from the environment is filtered through the near-infrared filter before receipt by the optical receiver elements.

9. The detection system of claim 1, wherein the line detector is a time delay integrating line camera.

10. The detection system of claim 1, wherein the optical receiver elements of the line detector are one of the following: a linear array of avalanche photodiodes; or a linear array of single photon avalanche photodiodes.

11. A method for capturing image data of an environment comprising:
providing a detection system on a vehicle, the detection system including:
a line detector including a plurality of optical receiver elements arranged in a line; and
an optical scanning element, the optical scanning element having a glass body defined by four glass sides and a reflective member within the glass body;
rotating the optical scanning element around an axis to change a field of view of the line detector with respect to the environment;
as the optical scanning element rotates, receiving light from the environment, by the optical receiver elements, such that the line detector captures an image of the environment in a series of line scans.

12. The method of claim 11, wherein an exterior of the glass body is formed by four transmissive faces, the four transmissive faces including:
a first pair of two transmissive faces on a first side of the reflective member and forming a first isosceles right triangular prism with the reflective member such that the reflective member is the hypotenuse; and
a second pair of two transmissive faces on a second side of the reflective member and forming a second isosceles right triangular prism with the reflective member such that the reflective member is the hypotenuse.

13. The method of claim 11, wherein the detection system further includes a light transmitter, the method further comprising:
transmitting, with the light transmitter, a light beam into the environment; and
receiving, with the line detector, the light beam after the light beam returns from the environment.

14. The method of claim 13, wherein the detection system includes a light transmitter, the method further comprising:
positioning the light transmitter to face orthogonal to the optical receiver elements of the line detector.

15. The method of claim 14, wherein the detection system includes a 90 degree reflector, the method comprising:
arranging the 90 degree reflector such that the light transmitter and the line detector are co-axial; and
redirecting, with the 90 degree reflector, the light beam from the light transmitter towards the optical scanning element.

16. The method of claim 15, wherein the 90 degree reflector is one or more of the following: a reflective mirror; a reflective prism; or a polarized beam splitter.

17. The method of claim 15, wherein the detection system further includes a Powell lens, the method further comprising:
positioning the Powell lens between the 90 degree reflector and the optical scanning element; and
expanding the light beam from a pencil beam into a fan beam, with the Powell lens, the Powell lens directing the fan beam towards the optical scanning element co-axial to the line detector.

18. The method of claim 13, wherein:
the light transmitter is a near-infrared laser transmitter and the light beam is near-infrared light; and
the detection system further comprises a near-infrared filter, the method further comprising:
positioning the near-infrared filter between the optical scanning element and the line detector such that light from environment passes through the near-infrared filter before receipt by the optical receiver elements.

19. The method of claim 11, wherein the line detector is a time delay integrating line camera.

20. The method of claim 11, wherein the optical receiver elements of the line detector are one of the following: a linear array of avalanche photodiodes; or a linear array of single photon avalanche photodiodes.
